(19) United States
(12) Patent Application Publication
(10) Pub. No.: US 2007/0038429 A1
(43) Pub. Date: Feb. 15, 2007

(54) System simulation method

(75) Inventors: Masato Tatsuoka, Kawasaki (JP); Atsushi Ike, Kawasaki (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/336,967

(22) Filed: Jan. 23, 2006

(30) Foreign Application Priority Data
Jul. 27, 2005 (JP) 2005-217114

(51) Int. Cl. G06F 17/50

(52) U.S. Cl. 703/14

(57) ABSTRACT

A system simulation method preventing the simulation speed from lowering. An initialization section allocates an area corresponding to a certain area on a memory model to be accessed by a user hardware model, as a user hardware memory, on a computer memory. Memory access from the user hardware model is always made to the user hardware memory. An access control section enables memory access from a processor core model to the user hardware memory and controls the memory access so that no conflict occurs with the access from the user hardware model.

### CROSS-REFERENCE TO RELATED APPLICATIONS

This application is based on, and claims priority to, Japanese Application No. 2005-217114, filed Jul. 27, 2005, in Japan, and which is incorporated herein by reference.

### BACKGROUND OF THE INVENTION

1. Field of the Invention

The present invention relates to system simulation methods, and particularly to a system simulation method for performing computer verification of a function of a logic circuit containing both a processor core and user hardware.

2. Description of the Related Art

A model simulator of a system-on-chip (SoC) model containing both a central processing unit (CPU) core and user hardware should implement both a function to simulate the operation of the CPU for verifying software and a simulation function to verify the user hardware simultaneously.

FIG. 14 shows the configuration of a conventional SoC model simulator.

The conventional SoC model simulator includes a processor core model 901 which models the functions of the CPU running software to be verified, a user hardware model 902 which models the functions of the user hardware to be verified, a memory model 903 which models a memory having a certain structure, and a memory access application program interface (API) function 904. The memory access API function 904 converts data into a format suited to the structure of the memory model 903 and accesses the memory model 903 when called with an address, size, or the like used as an argument. The processor core model 901 and the user hardware model 902 read and write the memory model 903 through the memory access API function 904.

The processor core model 901, the user hardware model 902, the memory model 903, and the memory access API function 904 are implemented by software, and loaded into and executed by a personal computer (PC) or a workstation. The SoC model simulator is hereafter referred to as a system simulator.

In the conventional system simulator, a single memory model 903 manages the memory space to maintain consistency. While either the processor core model 901 or the user hardware model 902 is accessing the memory model 903 through the memory access API function 904, the other cannot access it until the access ends.

One proposed system simulator has one memory model each for the user hardware model and the processor core model in order to reduce the verification time, and an interface model is included to connect the two models to maintain consistency in information exchange (for example, refer to Japanese Unexamined Patent Application Publication No. 2000-35898, paragraphs [0022] to [0031] and FIG. 1).

In the conventional system simulation, the processor core model 901 and the user hardware model 902 access the memory model 903 through the memory access API function 904 used in common. This structure causes the simulator to become slow as the frequency of access (calling of the memory access API function 904) increases.

Especially, a system in which user hardware frequently reads or writes data in memory, such as an image processing system, has such a general configuration that the user hardware handles image data processing and the processor controls data processing by the user hardware and runs the operating system (OS). When the operation of that type of system is verified by the conventional system simulator, a great amount of access from the user hardware model 902 keeps the processor core model 901 waiting for memory access, degrading the performance of the SoC model, such as significantly decreasing the speed. This problem has a great effect on the development of software such as firmware to be verified by the processor core model 901, adversely affecting the entire process of the SoC design.

In some configurations of the simulation model having one memory model each for the user hardware model and the processor core model and an interface model for synchronizing those models, synchronization may be frequently performed. The frequent synchronization will decrease the simulation speed extremely.

### SUMMARY OF THE INVENTION

In view of the foregoing, it is an object of the present invention to provide a system simulation method which can prevent simulation speed from decreasing.

To accomplish the above object, according to the present invention, there is provided a system simulation method for verifying, on a computer, a function of a target logic circuit containing both a processor core and user hardware. This system simulation method uses a processor core model which models the functions of the processor core, a user hardware model which models the functions of the user hardware, and a memory model which models the structure of the memory of the target logic circuit, all of which being built on the computer, and includes the following steps: An initialization section allocates a user hardware memory corresponding to the area of the memory model used by the hardware model to a memory area of the computer, and changes the access destination of the user hardware model to the user hardware memory; and an access control section controls the access destination of the processor core model in accordance with an access request.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows a concept of the present invention applied to an embodiment.

FIG. 2 is a functional block diagram of a system simulator of the embodiment of the present invention.

FIG. 3 is a view showing an example of access to a memory model of the present embodiment.

FIG. 4 is a flow chart showing a first procedure for selecting the memory to be accessed according to the present embodiment.

FIG. 5 is a flow chart showing a second procedure for selecting the memory to be accessed according to the present embodiment.

FIG. 6 is a block diagram showing the hardware configuration of the simulator of the present embodiment.

FIG. 7 is a view showing a procedure for loading an execution program, according to the simulation method of the present embodiment.

FIG. 8 is a view showing a procedure for starting the execution program, according to the simulation method of the present embodiment.

FIG. 9 is a view showing a procedure for accessing data (outside a UHW memory area) by a core model, according to the simulation method of the present embodiment.

FIG. 10 is a view showing a procedure for accessing data (in the UHW memory area without conflict) by the core model, according to the simulation method of the present embodiment.

FIG. 11 is a view showing a procedure for accessing data (in the UHW memory with a conflict) by the core model, according to the simulation method of the present embodiment.

FIG. 12 is a view showing a procedure for ending simulation, according to the simulation method of the present embodiment.

FIG. 13 is a view showing a flow of processing when the simulation method of the present embodiment is multi-threaded.

FIG. 14 shows the configuration of a conventional SoC model simulator.

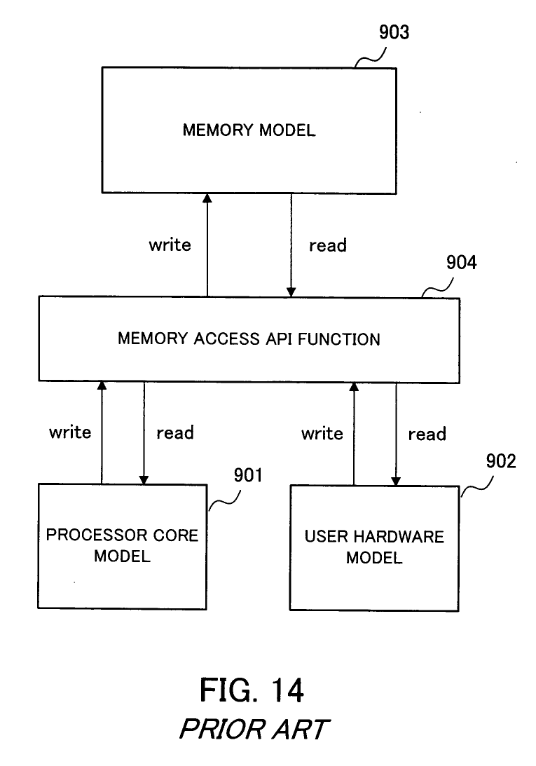

### DESCRIPTION OF THE PREFERRED EMBODIMENTS

An embodiment of the present invention will be described below with reference to the drawings. An overview of the invention applied to the embodiment will be described, and then the embodiment will be described in detail.

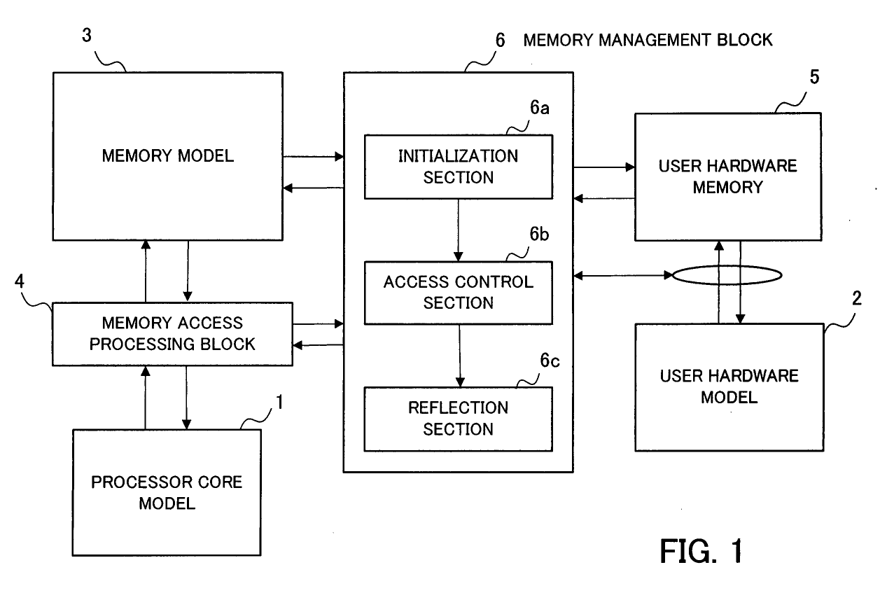

FIG. 1 shows a concept of the present invention applied to the embodiment.

A system simulator according to the present invention is applied to a system simulation for verifying a target logic circuit by using models implementing the functions of different blocks of the target logic circuit by software on a computer. The system simulator includes a processor core model 1, a user hardware model 2, a memory model 3, a memory access processing block 4, a user hardware memory 5, and a memory management block 6. The target logic circuit includes a memory which has a certain structure, user hardware which frequently accesses the memory alone and executes certain computation, and a CPU core which occasionally references the result of computation by the user hardware and, when necessary, controls the user hardware to change the processing or for other purposes.

The processor core model 1 models the functions of the CPU core of the target logic circuit. The processor core model 1 is built on a computer when a program implementing the functions of the CPU core is executed on the computer. The processor core model 1, built on the computer, reads target programs successively, decodes read data, and executes decoded instructions. Memory access in this processing is made through the memory access processing block 4.

The user hardware model 2 models the functions of the user hardware of the target logic circuit. The user hardware model 2 is built on the computer when a program implementing the functions of the user hardware is executed on the computer. The user hardware model 2, built on the computer, processes certain input signals successively in accordance with the logic of the user hardware and connection information of circuit elements, and generates output signals. When the processor core model 1 issues a processing start instruction or when a certain condition is satisfied, the user hardware model 2 executes a series of computation and generates a result of computation. Memory access in the processing is made to the user hardware memory 5.

The memory model 3 models the memory structure of the target logic circuit. The memory model 3 is built on the computer when a program implementing data read or data write suited to the memory structure is executed on the computer. The memory model 3 includes an area for storing a target program executed by the processor core model 1, an area for storing information temporarily when the processor core model 1 executes a program, and an area for storing data for computation by the user hardware model 2. When the memory model 3 receives an access request of a certain format suited to the memory structure, from the memory access processing block 4 and the memory management block 6, the memory model 3 reads or writes data and responds in a certain format.

The memory access processing block 4 receives a memory access request from the processor core model 1 and, if the requested access address is not in the user hardware memory 5, converts the address to a format suited to the data structure of the memory model 3, and accesses the memory model 3 to read or write data, in cooperation with the memory management block 6. If the requested access address is in the user hardware memory 5, the memory access processing block 4 passes the access request to the memory management block 6.

The user hardware memory 5 is allocated on the memory of the computer, in correspondence with a storage area for computation to be accessed by the user hardware model 2, in the area of the memory model 3, by the memory management block 6. This memory is a normal memory area (allocated by the OS of the computer) without structure and can be accessed directly from the user hardware model 2. With this memory, the access speed by the user hardware model 2 can be enhanced, in comparison with when data is converted in accordance with the memory structure.

The memory management block 6 includes an initialization section 6a, an access control section 6b, and a reflection section 6c, and performs management processing to maintain consistency between the memory model 3 and the user hardware memory 5. Before system simulation starts or when the memory space for the active user hardware is specified, the initialization section 6a allocates the user hardware memory 5 corresponding to the access area on the memory model 3 to be accessed by the user hardware model 2, on the memory of the computer, in accordance with the initialization information, and changes the access destination of the user hardware model 2 to the user hardware memory 5. The initialization information including the information of access area (start address, size, etc.) of the user hardware model 2 is set up in advance in the target program loaded through the processor core model 1, for instance. On some occasions such as when the target program is loaded, the initialization section 6a obtains the initialization information and performs initialization accordingly. When necessary, the initialization section 6a copies data stored in an area of the memory model 3 corresponding to the user hardware memory 5 into the user hardware memory 5 so that the contents agree with each other. Read access is made in the data format suited to the structure of the memory model 3.

The access control section 6b checks whether the requested destination address of the memory access request from the processor core model 1, obtained by the memory access processing block 4, is in the user hardware memory 5. If not, the access control section 6b reports the fact to the memory access processing block 4 and causes the memory access processing block 4 to execute memory access processing to the memory model 3. If the requested destination address is in the user hardware memory 5, the access control section 6b accesses the corresponding address of the user hardware memory 5. If an access request conflict occurs between the processor core model 1 and the user hardware model 2, an access sequence is determined in accordance with predetermined priority levels. If the user hardware model 2 has a higher priority level, the access request of the processor core model 1 is handled after the memory access by the user hardware model 2 ends. If the processor core model 1 has a higher priority level, the access processing of the user hardware model 2 is queued while the access request of the processor core model 1 is handled, and then the access right is passed to the user hardware model 2.

The memory access processing block 4 may check whether the requested destination address of the access request from the processor core model 1 is in the user hardware memory 5. In that case, the access control section 6b is called only when the memory access processing block 4 judges that the requested destination address is in the user hardware memory 5.

When simulation stops at the end, or at a break in debugging of software that allows read access to the memory model 3, the reflection section 6c writes the contents of the user hardware memory 5 into the memory model 3 so that the contents agree with each other. The data is converted into the data structure of the memory model 3 before they are written.

A procedure of system simulation utilizing the system simulator as described above will be described.

The processor core model 1, the user hardware model 2, the memory model 3, and the memory access processing block 4 of the target logic circuit are built on a computer used for simulation. When a target program is read prior to the start of simulation, the initialization section 6a of the memory management block 6 allocates the user hardware memory 5 on a memory of the computer, in accordance with the designation of an access area in the memory model 3 accessed by the user hardware model 2, included in the initialization information of the target program. Then, the access destination of the user hardware model 2 is changed to the user hardware memory 5. After that, the user hardware model 2 accesses the user hardware memory 5 instead of the memory model 3.

Simulation starts, and the computation of the user hardware model 2 starts in accordance with, for instance, a start instruction from the processor core model 1. Memory access from the user hardware model 2 is made to the user hardware memory 5. Memory access from the processor core model 1 is received by the memory access processing block 4, and either the memory access processing block 4 or the access control section 6b of the memory management block 6 checks whether the requested address is in the user hardware memory 5. If the requested address is not in the user hardware memory 5, the memory access processing block 4 performs conversion into a format suited to the data structure of the memory model 3, and then data is read or written accordingly. If the requested address is in the user hardware memory 5, the access control section 6b accesses the address of the user hardware memory 5, and reads or writes data accordingly. If the user hardware model 2 also attempts to access the user hardware memory 5, exclusive processing is performed. Memory access given a higher priority level in advance is handled earlier, and after the access processing ends, the other memory access is handled.

When simulation ends, the reflection section 6c of the memory management block 6 copies the contents of the user hardware memory 5 into the corresponding area of the memory model 3, and the contents agree with each other. The same processing is performed at a break in software debugging.

The memory area to be accessed by the user hardware model 2 is provided besides the memory model 3, so that the frequency of access conflict between the processor core model 1 and the user hardware model 2 can be reduced greatly. Consequently, the processor core model 1 and the user hardware model 2 can be executed in parallel, and the system simulation speed can be increased.

The user hardware memory 5 is a computer memory without a structure and can be accessed directly from the user hardware model 2, so that faster access is enabled.

An example of application of the present embodiment to simulation of a target logic circuit having a CPU core and user hardware operating in parallel will be described in detail with reference to the drawings.

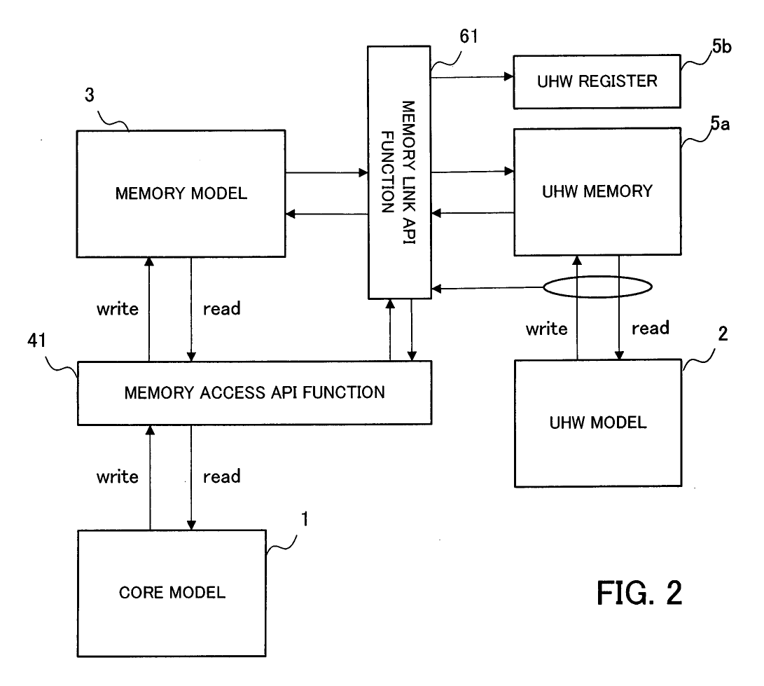

FIG. 2 is a functional block diagram of the system simulator of the embodiment of the present invention. Elements identical to those in FIG. 1 are indicated by the same reference characters.

The system simulator according to the present invention includes a processor core model (hereafter referred to as a core model) 1, a user hardware model (hereafter referred to as a UHW model) 2, a memory model 3, a memory access API function 41, a user hardware memory (hereafter referred to as a UHW memory) 5a, a user hardware register (hereafter referred to as a UHW register) 5b, and a memory link API function 61.

The memory access API function 41 serves as the memory access processing block 4, and is a function called at memory access by the core model 1.

In the UHW register 5b, a value indicating the memory area to be accessed by the UHW model 2, that is, the area to be accessed in the UHW memory 5a, is specified.

The memory link API function 61 is a function implementing the functions of the memory management block 6 and handles memory access in cooperation with the memory access API function 41.

The memory access API function 41 and the memory link API function 61 will be described in detail.

The memory access API function 41 is called at memory access by the core model 1 and has a function to convert data into a format suited to the structure of the memory model 3 and a function to link the memory link API function 61.

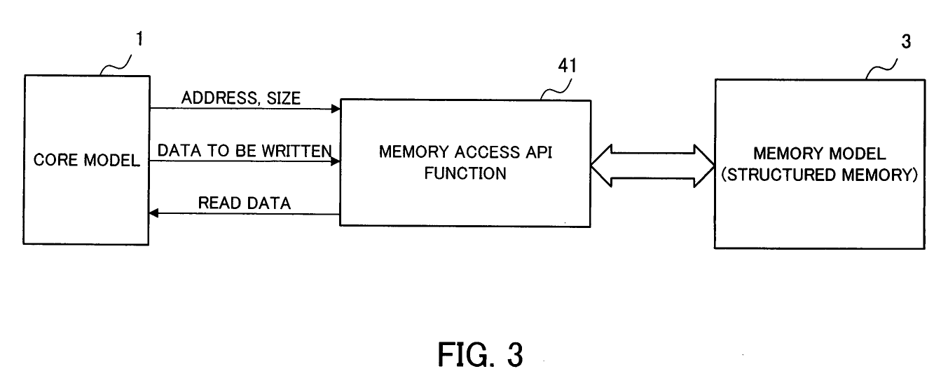

The data conversion function will be described first. FIG. 3 is a view showing an example of access to the memory model 3 of the present embodiment.

As described earlier, the memory model 3 is structured and must be accessed in a data format suited to the structure. The structure may have a memory attribute of the SoC model and may require an access request including the memory attribute, or the structure may require processing to save the memory. If the SoC model uses the big-endian format and if the computer uses the little-endian format, an endian conversion is necessary.

The core model 1 calls the memory access API function 41, using an address and size as arguments in read access or using an address and size, and further data to be written as arguments in write access. The memory access API function 41 carries out conversion to a data format suited to the structure of the memory model 3 as described above and makes an access request. Read data is subjected to reverse conversion and is returned to the core model 1. The format depends on the model.

When the core model 1 requests to access an address in the UHW memory 5a, the function to link the memory link API function 61 asks the memory link API function 61 to access the UHW memory 5a.

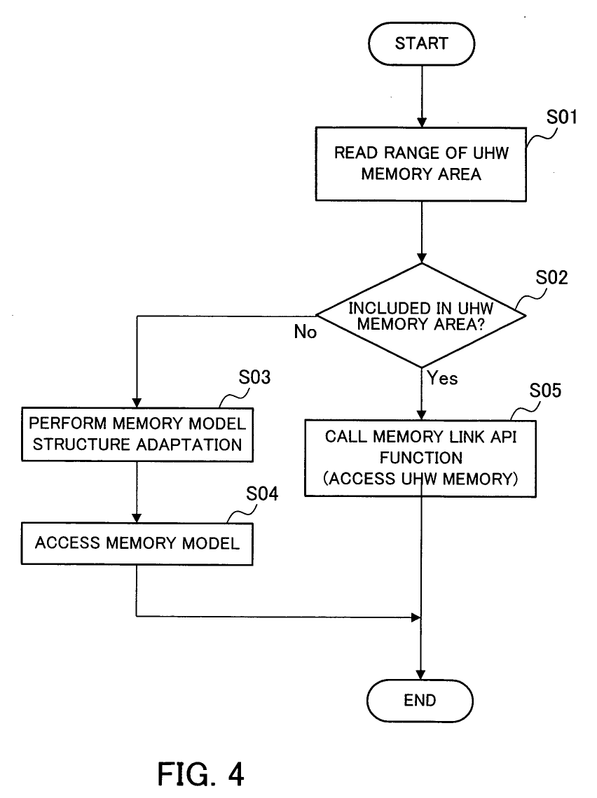

FIG. 4 is a flow chart showing a first procedure for selecting the memory to be accessed according to the present embodiment. When the core model 1 accesses memory, the memory access API function 41 is called and starts the processing.

Step S01: The function reads the range of the UHW memory area. The range of the UHW memory area is obtained by reading the initialization information stored in the memory model 3 or by reading values of the UHW register 5b through the memory link API function 61.

Step S02: The function compares the requested memory access destination of the core model 1 with the range of the UHW memory area read in step S01, and checks whether the requested access destination is included in the UHW memory area. If yes, the processing proceeds to step S05.

Step S03: If the requested access destination is not included in the UHW memory area, memory model structure adaptation is performed to convert the access request into a data format suited to the structure of the memory model 3.

Step S04: The function accesses the memory model 3 in accordance with the access request in the data format suited to the structure of the memory model 3 obtained in step S03, and then ends the processing.

Step S05: If the requested access destination is included in the UHW memory area, the function calls the memory link API function 61 to access the UHW memory 5a, and then ends the processing.

The address check may be performed by the memory link API function 61 instead of the memory access API function 41.

The memory link API function 61 is called by the memory access API function 41, and is also called when a certain condition is satisfied, such as at the end of simulation or a break in debugging. The memory link API function 61 links the UHW memory 5a with the memory model 3. More specifically, the memory link API function 61 has a function to handle access to the UHW register 5b, a function to handle access from the core model 1 to the UHW memory 5a, an exclusive processing function to be executed at an access conflict between the core model 1 and the UHW model 2, and a data match function to match the memory model 3 and the UHW memory 5a.

The function to handle access to the UHW register 5b specifies the UHW memory 5a on the computer memory in initialization. The area of the UHW memory 5a used by the UHW model 2 depends on the register address and size specified by the core model 1. The memory is specified by allocating the computer memory to memory variables (pointers) of the registers. The start address and end address of the area of the UHW memory 5a can be found by specifying the start address and size in the registers.

For instance, when the address (Reg1Addr) is set to “0x01000000” and the size (Reg1Size) is set to “0x100” in a pair of registers 1, the memory area indicated by the pair of registers 1 has

a start address of Reg1Addr, and

an end address of (Reg1Addr+Reg1Size)

The UHW register 5b can have a plurality of these register pairs.

The function to handle access from the core model 1 to the UHW memory 5a is called by the memory access API function 41 and starts the processing.

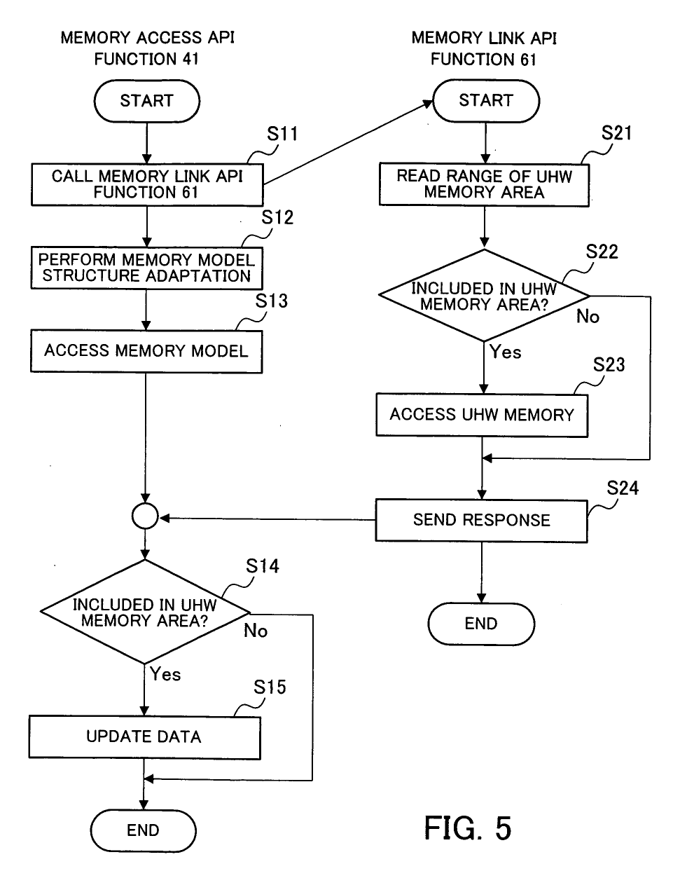

FIG. 5 a flow chart showing a second procedure for selecting the memory to be accessed according to the present embodiment. The figure shows the procedures of both the memory access API function 41 and the memory link API function 61.

The memory access API function 41 is called at memory access by the core model 1 and starts the following processing.

Step S11: When a memory access request is obtained from the core model 1, the function calls the memory link API function 61, sends the memory access request, and starts the processing.

Step S12: The function starts memory model structure adaptation to convert the access request into a data format suited to the memory model 3, without waiting for a response from the memory link API function 61, in order to reduce the processing time.

Step S13: The function accesses the memory model 3.

The requested access destination of the memory model 3 is accessed by following the processing procedure described above while a response from the memory link API function 61 is being waited for.

The memory link API function 61 activated in step S11 performs the following processing.

Step S21: The function reads the range of the UHW memory area. The range of the UHW memory area is obtained by reading the values of the UHW register 5b.

Step S22: The function specifies a response of invalid memory access as an initial value. The function compares the requested memory access destination of the core model 1 and the range of the UHW memory area read in step S21 to check whether the requested access destination is in the UHW memory area. If the requested access destination is not included in the UHW memory 5a, the function performs nothing and goes to step S24.

Step S23: If the requested access destination is included in the UHW memory area, the function accesses the requested access destination of the UHW memory 5a. In read access, the function reads data from the corresponding area of the UHW memory 5a and specifies a response to report the read data and the fact that the memory access has been made successfully. In write access, the function obtains the data to be written by the core model 1 through the memory access API function 41 and writes the data in the corresponding area of the UHW memory 5a. If an access conflict with the UHW model 2 occurs, exclusive processing, which will be described later, is performed. At the end of writing, the function specifies a response to report that the memory access has been made successfully.

Step S24: The function returns the response to the memory access API function 41 and ends the processing. If the access destination is in the UHW memory 5a, the response reporting the successful memory access (with the read data, in read access) has been specified in step S23. If the access destination is outside the UHW memory 5a, a response reporting that the memory access is invalid has been specified in step S22.

The continued processing of the memory access API function 41 will be described.

Step S14: The function obtains the response and checks based on the response whether access to the UHW memory area has been performed, that is, whether the memory access has been made successfully. If not, the function ends the processing and returns the result of the memory access in step S13 is returned to the core model 1.

Step S15: If the response tells that the UHW memory area has been accessed (successful memory access), the function updates data in accordance with the information obtained as the response. In read access, the function returns the data read from the UHW memory 5a by the memory link API function 61 to the core model 1. In write access, the function returns the result of successful writing in the UHW memory 5a by the memory link API function 61 to the core model 1.

In the description given above, in order to increase the processing speed, steps S12 and S13 of the memory access API function 41 are performed before a response is obtained from the memory link API function 61. These steps may also be carried out after the response is obtained if the access destination is determined to be outside the UHW memory area. Because data structure conversion by the memory access API function 41 is generally time-consuming, steps S12 and S13 should be performed before the determination, or, in access to the UHW memory 5a, step 13 should be interrupted, to enable faster access.

The exclusive access processing function performs exclusive processing if a conflict occurs between access from the core model 1 to the UHW memory 5a and access from the UHW model 2 to the UHW memory 5a. Access having a higher priority level is handled earlier, in accordance with the priority levels determined by the design specifications related to the access right of the core model 1 and the UHW model 2. When first access ends, the other access is performed. The major function of the core model 1 is generally designed to perform general control and not to overlap the processing by the UHW model 2. It is therefore assumed that the core model 1 and the UHW model 2 do not often share a memory area. The core model 1 and the UHW model 2 access different memory areas mostly.

The data match function between the memory model 3 and the UHW memory 5a matches the contents of the memory model 3 to the contents of the UHW memory 5a at a break in debugging software or firmware or at the end of simulation. The memory link API function 61 converts the data of the UHW memory 5a into a data format suited to the structure of the memory model 3 and transfers the data to the memory model 3.

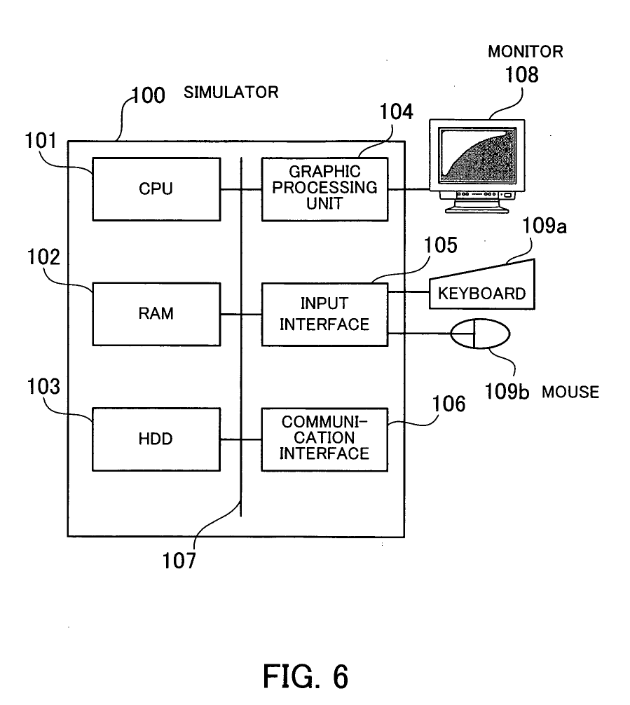

The hardware configuration of the simulator implementing the simulation method of the present embodiment will be described. FIG. 6 is a block diagram showing the hardware configuration of a simulator 100 of the present embodiment.

The whole of the simulator 100 is controlled by a CPU 101. The CPU 101 is connected through a bus 107 to a random access memory (RAM) 102, a hard disk drive (HDD) 103, a graphic processing unit 104, an input interface 105, and a communication interface 106.

The RAM 102 temporarily stores at least a part of an operating system (OS) and an application program to be executed by the CPU 101. The RAM 102 also stores a variety of data necessary for processing executed by the CPU 101. The HDD 103 stores the OS and the application program. The graphic processing unit 104 is connected to a monitor 108 and displays an image on the screen of the monitor 108 as instructed by the CPU 101. The input interface 105 is connected to a keyboard 109a and a mouse 109b, and sends a signal sent from the keyboard 109a or the mouse 109b through the bus 107 to the CPU 101. The communication interface 106 is connected to a network and exchanges data through the network with another apparatus.

A program implementing the above-described model of the target logic circuit and an execution program are loaded into the simulator 100, and simulation is performed.

The simulation method of the present embodiment will be described below.

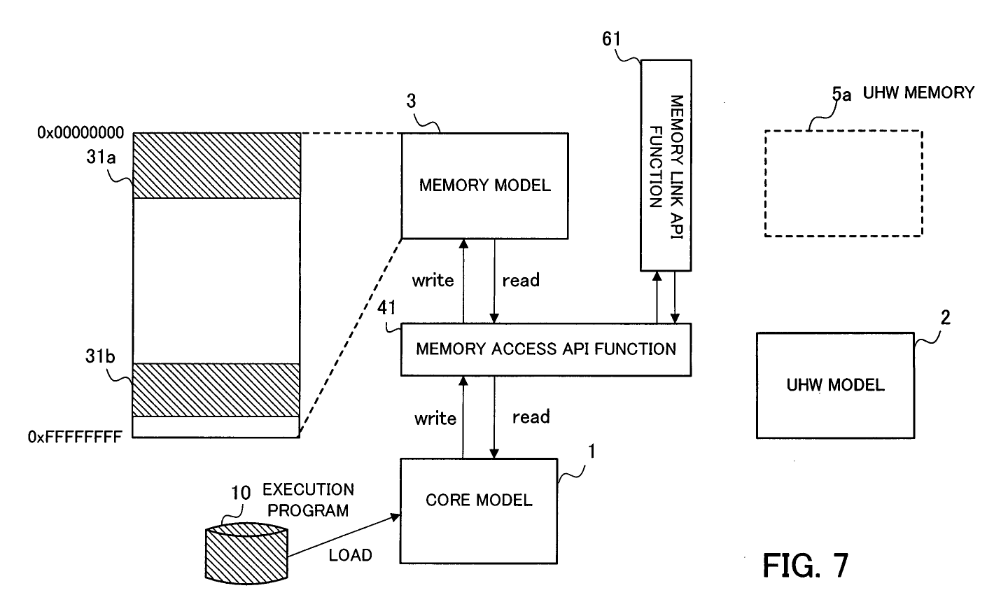

FIG. 7 is a view showing a procedure for loading the execution program, according to the simulation method of the present embodiment.

An execution program (load module) 10 such as firmware is loaded before an SoC model formed of the core model 1, the UHW model 2, the memory model 3, and the memory access API function 41 is started to begin simulation.

The core model 1 writes the execution program 10 through the memory access API function 41 into a certain area of the memory model 3. In the shown example, the execution program 10 is written in a memory area 31a and a memory area 31b. The execution program 10 includes instruction codes, and initial values of data space setting, peripheral circuit setting, register setting, and the like, or initialization instructions therefor. The data space, peripheral circuit, and registers are set up by the execution program 10 or in accordance with the initialization information. The memory area of the user hardware model 2 is specified by a register. In the shown example, the register has not yet been set, and the UHW memory 5a is not specified on the computer memory. When the register of the UHW model 2 is specified at initialization, the UHW memory 5a is allocated simultaneously.

The operation to start the execution program 10 by the core model 1 will described below.

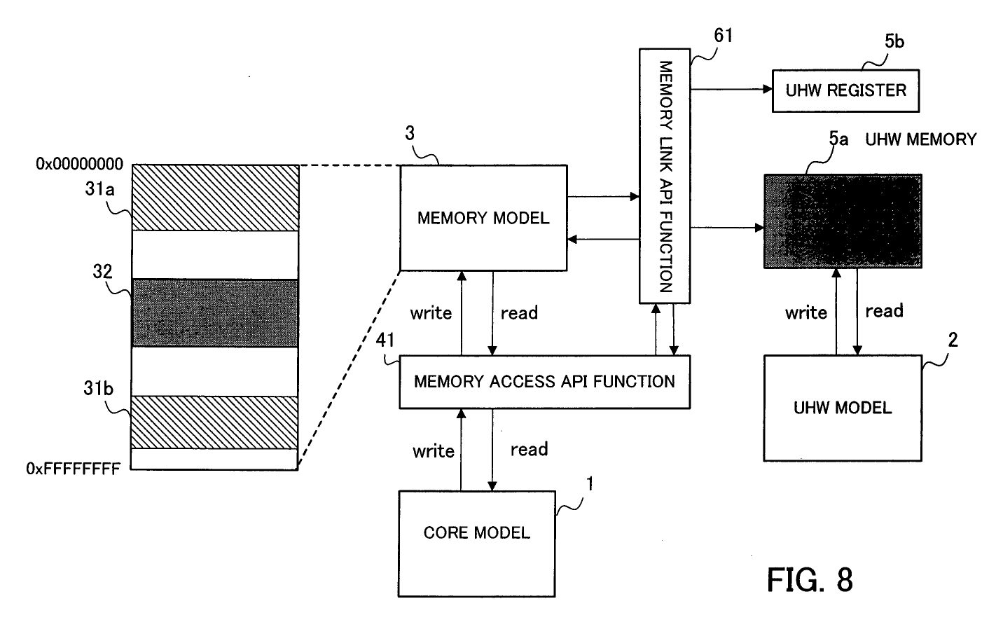

FIG. 8 is a view showing a procedure for starting the execution program 10, according to the simulation method of the present embodiment.

The execution program 10 may include a register write instruction which specifies the memory space to be used by the UHW model 2. If that type of instruction is found, the core model 1 specifies an UHW area 32 in the memory model 3 through the memory access API function 41 in accordance with the instruction. At the same time, the core model 1 writes the area setting of the UHW memory 5a in the UHW register 5b through the memory link API function 61 and allocates the UHW memory 5a on the computer memory. Both the area 32 on the memory model 3 and the UHW memory 5a are allocated as memory areas of the UHW model 2.

The operation performed when the core model 1 attempts to access the UHW memory 5a will be described.

When the core model 1 attempts to access memory, the memory access API function 41 or the memory link API function 61 checks whether the memory access destination is in the UHW memory 5a. If not, the memory model 3 is accessed through the memory access API function 41. If the UHW memory 5a includes the access destination, the UHW memory 5a is accessed through the memory link API function 61.

The two cases will be described with reference to the drawings. In the description below, it is supposed that the memory access API function 41 checks the range of the UHW memory area and that the memory access API function 41 can read the contents of the UHW register 5b directly. The same data as in the UHW register 5b may be stored in an area that can be read directly by the memory access API function 41, and referenced instead of the data of the UHW register 5b.

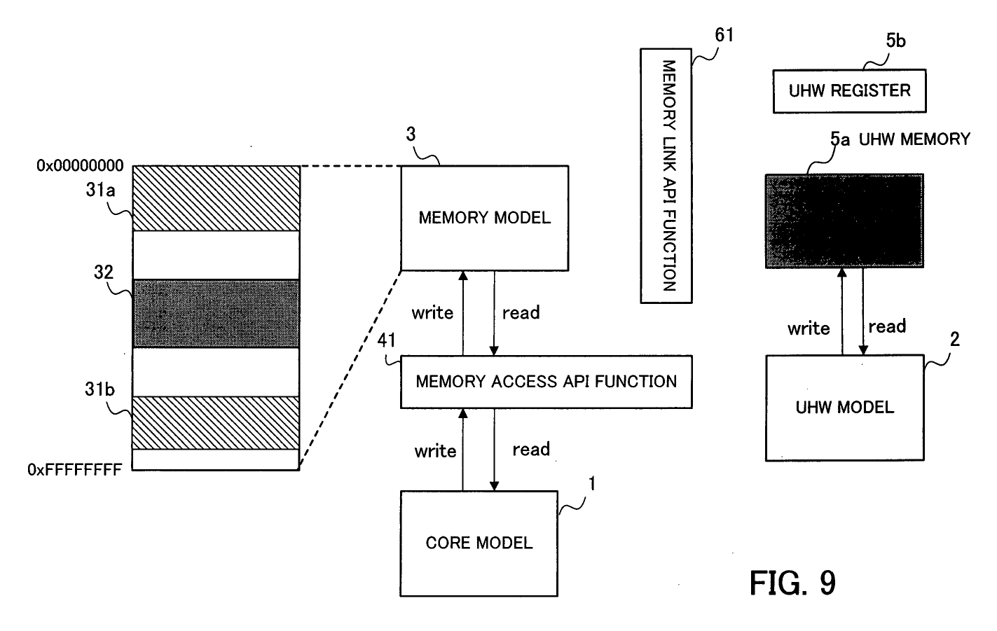

FIG. 9 is a view showing a procedure for accessing data (outside the UHW memory area) by the core model 1, according to the simulation method of the present embodiment.

When the core model 1 attempts to access an area outside the UHW memory 5a, the memory access API function 41 is called. The memory access API function 41 checks whether the requested access destination is in the UHW memory 5a and finds that the access destination is not included. The memory access API function 41 accesses the corresponding area of the memory model 3. The memory link API function 61 is not started, as shown in the figure. The UHW model 2 can access the UHW memory 5a as required, regardless of the access status of the core model 1. If the access destinations of the core model 1 and the UHW model 2 are in different address spaces (no access conflict), the core model 1 and the UHW model 2 can access the memory model 3 and the UHW memory 5a, respectively, as required in parallel. Accordingly, a multi-threaded SoC model enables fast simulation.

An operation performed when the core model 1 attempts to access the UHW memory 5a and no conflict occurs with the UHW model 2 will be described.

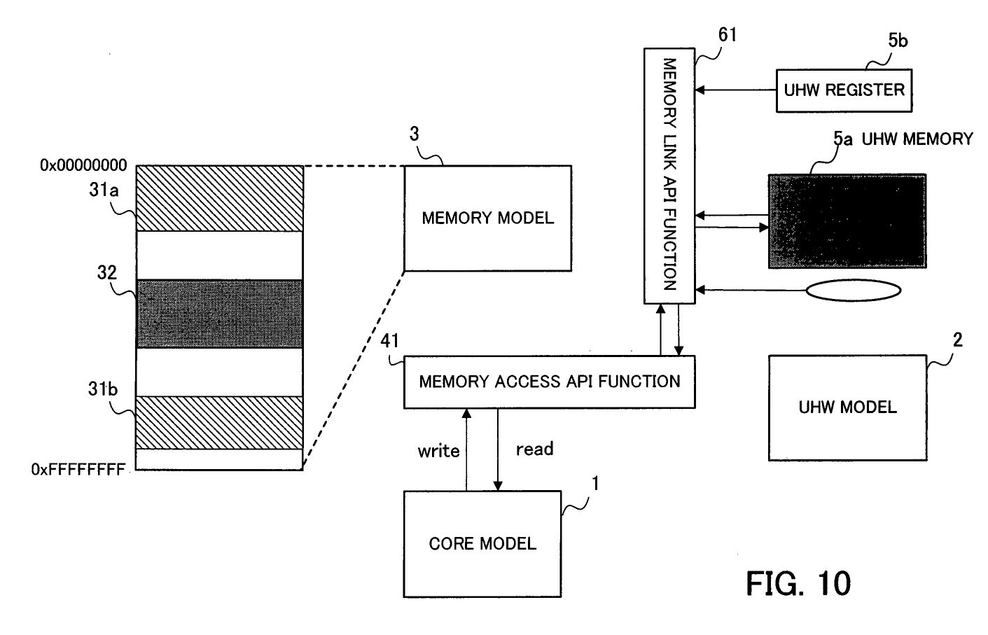

FIG. 10 is a view showing a procedure for accessing data (in the UHW memory area without conflict) by the core model 1, according to the simulation method of the present embodiment.

When the core model 1 attempts to access a memory area in the UHW memory 5a, the memory access API function 41 is called. The memory access API function 41 checks whether the requested access destination is in the UHW memory 5a, finds that the access destination is included, and passes the memory access request to the memory link API function 61. The memory link API function 61 checks the access status of the UHW model 2, and, if no conflict is found, accesses the UHW memory 5a in accordance with the access request of the core model 1 obtained through the memory access API function 41. In read access, read results are returned to the core model 1 through the memory access API function 41.

Because the core model 1 and the UHW model 2 do not conflict, the memory areas can be accessed in parallel. Accordingly, a multi-threaded SoC model enables fast simulation.

An operation performed when the core model 1 attempts to access the UHW memory 5a and a conflict with the UHW model 2 occurs will be described.

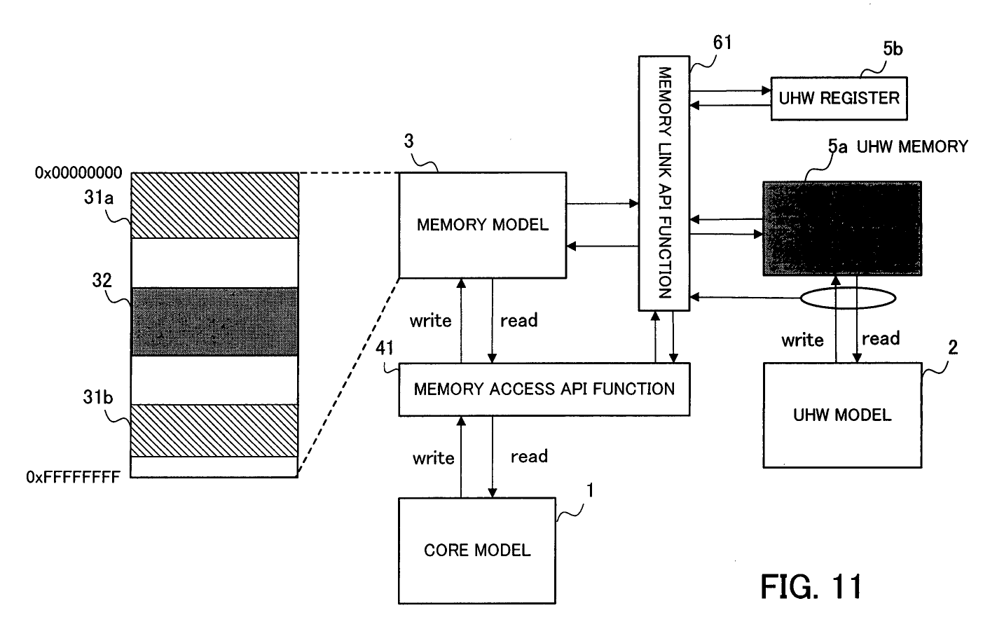

FIG. 11 is a view showing a procedure for accessing data (in the UHW memory with a conflict) by the core model 1, according to the simulation method of the present embodiment.

When the core model 1 attempts to access a memory area in the UHW memory 5a, the memory access API function 41 is called. The memory access API function 41 checks whether the requested access destination is in the UHW memory 5a, and because the destination is included, passes the access request to the memory link API function 61. The memory link API function 61 checks the access status of the UHW model 2 and finds that there is a request to access the same space (conflict). If there are multiple requests to access the same memory area, a request having a higher priority level is executed by exclusive control. If the UHW model 2 has a higher priority level, read or write access by the UHW model 2 is performed first, then the UHW memory 5a is accessed in accordance with the access request of the core model 1 obtained through the memory access API function 41. If the core model 1 has a higher priority level, the access request by the UHW model 2 is queued, the access request by the core model 1 is handled, and then the access request by the UHW model 2 is dequeued. The priority levels depend on the specifications of the SoC model. The priority levels of write access may differ from the priority levels of read access.

When a conflict occurs between access requests, the processing is performed as described above. If an access request is made while access is in progress, the ongoing access processing has precedence over the access request.

The operation to reflect the contents of the UHW memory 5a into the memory model 3 after simulation or the like will be described.

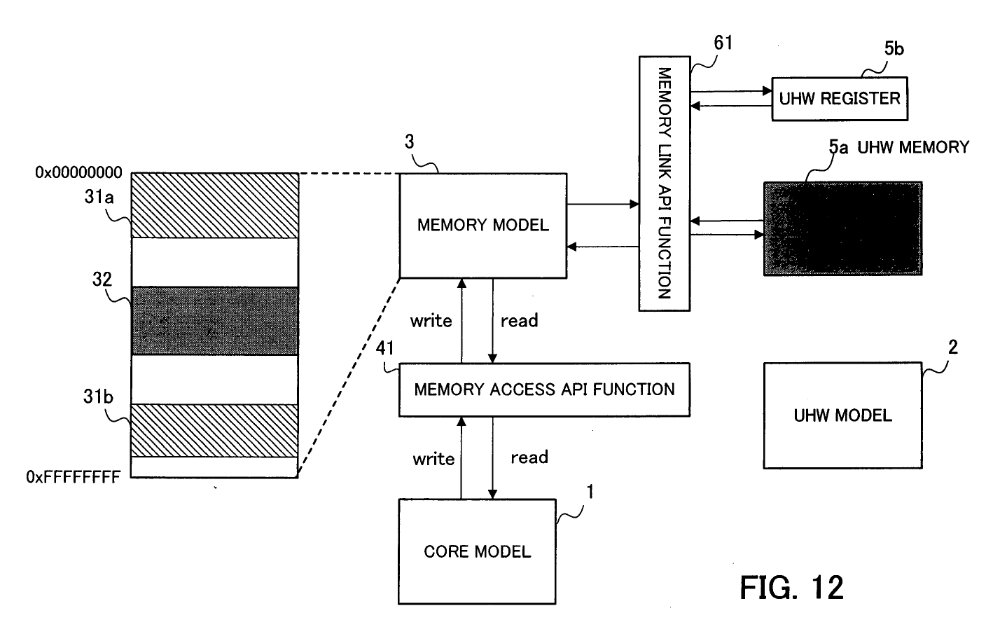

FIG. 12 is a view showing a procedure for ending simulation, according to the simulation method of the present embodiment. The same processing is performed also at a break of debugging or in a pause of simulation.

When simulation stops, the memory link API function 61 is called. The memory link API function 61 writes the contents of the UHW memory 5a into the corresponding UHW area 32 of the memory model 3 so that the UHW memory 5a and the memory model 3 have the same data. Before writing data, the memory link API function 61 converts the data of the UHW memory 5a without structure into a format suited to the structure of the memory model 3.

Because the memory area for the UHW model 2 is allocated on the computer memory without structure, the core model 1 and the UHW model 2 can access respective memory areas in parallel without causing a conflict. Because the UHW memory 5a for the UHW model 2 is allocated on the computer, the access speed by the UHW model 2 can be enhanced. Consequently, a multi-threaded SoC model enables fast simulation.

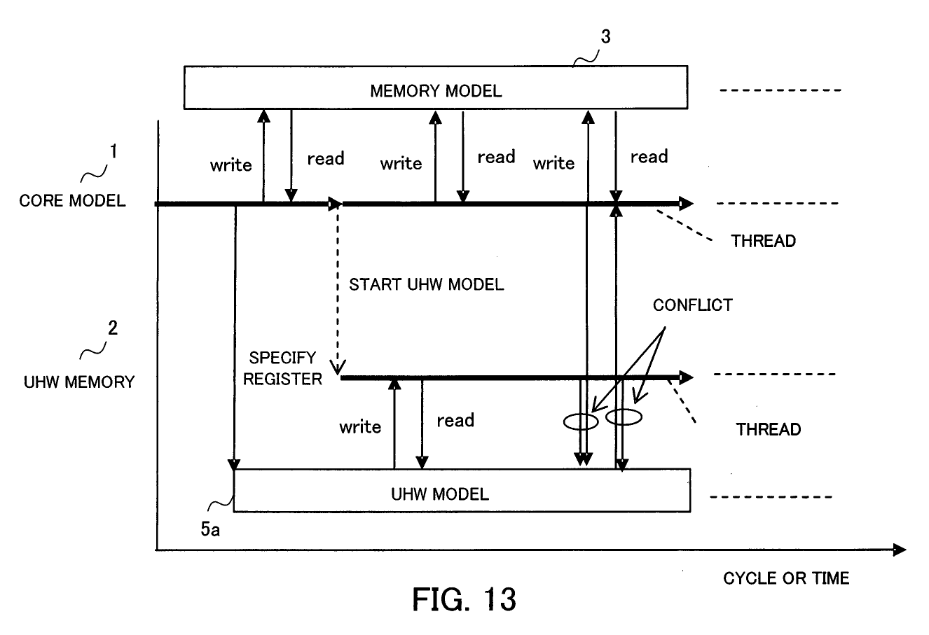

FIG. 13 is a view showing the flow of processing when the simulation method of the present embodiment is multi-threaded.

A thread to execute the core model 1 and a thread to execute the UHW model 2 proceed in parallel in a multi-thread configuration. The core model 1 executes processing in accordance with an execution program stored in the memory model 3 and specifies a UHW area of the memory model 3 as instructed. The UHW memory 5a used by the UHW model 2 is allocated on the computer, and the UHW model 2 is specified to access the UHW memory 5a.

The core model 1 activates the UHW model 2 when needed, in accordance with the execution program. After activating the UHW model 2, the core model 1 continues the processing in parallel with the UHW model 2. The UHW model 2 performs certain computation, accessing the UHW memory 5a. The two threads proceed in parallel.

If an access request from the core model 1 to the UHW memory 5a and an access request of the UHW model 2 conflicts with each other in that state, processing is performed in descending order of priority. In the shown example, data writing by the core model 1 is performed after access by the UHW model 2, and data reading by the processor core model 1 is performed before access by the UHW model 2.

The core model 1 and the UHW model 2 can access separate memory areas in parallel, enabling faster simulation.

In a system simulation method of the present invention, the processor core, user hardware, and memory of the target logic circuit are modeled on a computer. A user hardware memory is provided besides the memory model, and the user hardware model accesses the user hardware memory. Because the processor core model accesses the memory model mostly, even if a large amount of access is generated from the user hardware model to the user hardware memory, a suppressed effect is imposed on the access of the processor core model. Therefore, fast simulation is enabled.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A system simulation method for verifying, on a computer, a function of a target logic circuit containing a processor core and user hardware, the system simulation method using a processor core model which models the functions of the processor core, a user hardware model which models the functions of the user hardware, and a memory model which models the structure of the memory of the target logic circuit, all of which being built on the computer, and comprising the steps of:
an initialization step allocating a user hardware memory corresponding to the area of the memory model used by the user hardware model to a memory area of the computer, and changing the access destination of the user hardware model to the user hardware memory; and
an access control step controlling the access destination of the processor core model in accordance with an access request.

2. The system simulation method according to claim 1, wherein the access control step checks a memory access request from the processor core model with regard to whether the requested access destination is included in the memory area provided as the user hardware memory; and, if the destination is not included, the memory model is designated as the access destination, or, if the destination is included, the user hardware memory is designated as the access destination.

3. The system simulation method according to claim 2, wherein the access control step handles an access request having a higher priority level earlier in accordance with predetermined priority levels when the access destination of the processor core model is in the user hardware memory and when the user hardware model makes an access request to the same memory area.

4. The system simulation method according to claim 2, wherein the access control step does not execute processing for the memory access request from the processor core model, with regard to the user hardware memory or the memory model which is not selected as the access destination of the processor core model.

5. The system simulation method according to claim 1, wherein the initialization step allocates the user hardware memory to the memory area of the computer in accordance with initialization information specified in a target program to be executed by the processor core model when the target program is loaded into the memory model.

6. The system simulation method according to claim 1, wherein a reflection step reflects the contents of the user hardware memory into the memory model, at the end of the system simulation or in a pause of the system simulation.

7. The system simulation method according to claim 6, wherein the contents of the user hardware memory are converted into a format suited to the data structure of the memory model and then written into the memory model when the contents of the user hardware memory are reflected into the memory model.

8. A system simulator for verifying a function of a target logic circuit containing a processor core and user hardware, the system simulator comprising on a computer:
a processor core model block which models the functions of the processor core;
a user hardware model block which models the functions of the user hardware;
a memory model block which models the structure of a memory of the target logic circuit;
a user hardware memory which is used by the user hardware model block;
an initialization means which allocates an area corresponding to the area of the memory model block accessed by the user hardware model block as the user hardware memory, in a memory area of the computer; and
a memory management block which, when an access request is made from the user hardware model block to the memory model block, handles the access request to an area of the user hardware memory corresponding to an area of the memory model block to be accessed.
